(19) United States
(12) Patent Application Publication
(10) Pub. No.: US 2025/0109303 A1
(43) Pub. Date: Apr. 3, 2025

(54) POWDER COATING COMPOSITIONS INCLUDING RETROREFLECTIVE PARTICLES

(71) Applicant: PPG Industries Ohio, Inc., Cleveland, OH (US)

(72) Inventors: Paul William Bradley, Corinth, TX (US); Manish Kr Mishra, Pittsburgh, PA (US)

(21) Appl. No.: 18/887,377

(22) Filed: Sep. 17, 2024

Related U.S. Application Data
(60) Provisional application No. 63/586,035, filed on Sep. 28, 2023.

(51) Int. Cl. C09D 5/03; C09C 1/30; C09C 3/00; C09C 3/06; C09C 3/10; C09D 5/33; C09D 7/40; C09D 7/62; C09D 167/00

(52) U.S. Cl. CPC C09D 5/035; C09C 1/3054; C09C 1/3072; C09C 1/309; C09C 3/006; C09C 3/066; C09C 3/10; C09D 5/004; C09D 7/62; C09D 7/67; C09D 7/70; C09D 167/00; C01P 2004/32; C01P 2004/64; C01P 2004/80; C01P 2006/60

(57) ABSTRACT

A retroreflective powder coating composition including a film-forming resin and a plurality of retroreflective particles. The film-forming resin including a base particle, a metallic coating, a pigment coating composition, and a substantially transparent siloxane coating.

### CROSS-REFERENCE TO RELATED APPLICATIONS

This application claims the benefit under 35 U.S.C. § 119(e) of U.S. Provisional Application No. 63/586,035 entitled “POWDER COATING COMPOSITIONS INCLUDING RETROREFLECTIVE PARTICLES”, filed on Sep. 28, 2023, which is incorporated by reference in its entirety.

### FIELD

The present disclosure relates to a powder coating composition including retroreflective particles.

### BACKGROUND

Retroreflective coatings, such as powder coatings, may improve visibility of coated articles in low light and dark conditions. To make a coating retroreflective, retroreflective beads may be added into a coating composition. Particularly, when applied over a surface of the substrate, retroreflective coatings reflect incident light back in the direction of the light source such that the substrate is more visible to an individual observing the substrate. Because retroreflective coatings improve the visibility of objects under low light conditions (e.g. at night), these coatings are typically applied over traffic signs, road markings, bicycles, automotive components, and the like to reflect incident light from headlights of oncoming vehicles back to the driver, thereby improving visibility of the coated components.

Retroreflective coatings typically incorporate retroreflective particles, such as glass beads, which may be transparent or silvery grey in color. However, there is a need to formulate retroreflective coatings, such as pigmented powder coatings, that incorporate retroreflective particles and yet maintain the color integrity of the coating.

### SUMMARY

The present disclosure provides a retroreflective powder coating composition including a film-forming resin; and a plurality of retroreflective particles. The retroreflective particles each include a base particle; a metallic coating disposed over at least a portion of the base particle; a pigment coating composition disposed over the metallic coating and/or the base particle; and a substantially transparent siloxane coating disposed over at least a portion of the pigment coating composition. The pigment coating composition includes a binder resin; and an organic pigment.

The present disclosure further provides an article having a surface at least partially coated with a coating formed from a retroreflective powder coating composition including a film-forming resin and a plurality of retroreflective particles.

The present disclosure provides a method of coating an article including applying a retroreflective powder coating composition over at least a portion of a surface of the article; and curing the composition to form a coating. The coating includes a coefficient of retro-reflection (RA) of at least 6 cd/ft/ft2 as measured using a retroreflectometer with an entrance angle of −4° and an observation angle of 0.2° in accordance with ASTM E1709.

Additionally, the present disclosure provides a method for producing retroreflective particles for use in a powder coating composition including applying a liquid pigment coating composition over at least portions of a plurality of retroreflective particles to form pigmented retroreflective particles; and applying a substantially transparent siloxane coating over the pigmented retroreflective particles. The liquid pigment coating composition includes a binder resin and an organic pigment. Each retroreflective particle includes a base particle having a metallic coating disposed over at least a portion of the base particle.

### BRIEF DESCRIPTION OF THE DRAWINGS

The above-mentioned and other features and advantages of this disclosure, and the manner of attaining them, will become more apparent and the disclosure itself will be better understood by reference to the following description taken in conjunction with the accompanying drawings. These above-mentioned and other features of the disclosure may be used in any combination or permutation.

FIG. 1 is an illustration of surface modification of retroreflective particles.

Corresponding reference characters indicate corresponding parts throughout the several views. The exemplifications set out herein illustrate the disclosure, and such exemplifications are not to be construed as limiting the scope of the disclosure in any manner.

### DETAILED DESCRIPTION

The present disclosure provides a retroreflective powder coating composition including a film-forming resin and a plurality of retroreflective particles.

### I. Definitions

For purposes of the following detailed description, it is to be understood that the disclosure may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” For example, numerical ranges provided for weight percentages of components or amounts of components added should be construed as being modified by the term “about.” Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Whereas particular examples of this disclosure have been described above for purposes of illustration, it will be evident to those skilled in the art that numerous variations of the details of the present disclosure may be made without departing from what is defined in the appended claims.

Also, it should be understood that any numerical range recited herein is intended to include all sub-ranges subsumed therein. For example, a range of “1 to 10” is intended to include all sub-ranges from (and including) the recited minimum value of 1 to the recited maximum value of 10, that is, having a minimum value equal to or greater than 1 and a maximum value of equal to or less than 10.

The use of the singular includes the plural and plural encompasses singular, unless specifically stated otherwise. In addition, the use of “or” means “and/or” unless specifically stated otherwise, even though “and/or” may be explicitly used in certain instances.

As used herein, the term “retroreflective” refers to the ability of a component or material to reflect incident light back in the direction of the light source.

As used herein, the term “powder coating composition” refers to a coating composition embodied in solid particulate form as opposed to liquid form.

As used herein, the term “resin” may be used interchangeably with “polymer.” The term polymer refers to oligomers and homopolymers (e.g., prepared from a single monomer species), copolymers (e.g., prepared from at least two monomer species), terpolymers (e.g., prepared from at least three monomer species), and graft polymers.

“Siloxane monomer” and “siloxane polymer” refer to a monomer or polymer, respectively, containing alternating silicon-oxygen linkages, e.g., O—Si—O and/or Si—O—Si linkages.

### II. Retroreflective Powder Coating Composition

The present disclosure provides a retroreflective powder coating composition generally including a film forming resin, retroreflective particles, and additives.

### A. Film Forming Resin

A film forming resin is a resin that can form a self-supporting continuous film on at least a horizontal surface of a substrate upon removal of any diluents or carriers present in the composition or upon curing. The film forming resin may further include a crosslinker.

The film forming resin may be a thermosetting coating composition and can include film-forming polymers or resins having functional groups that are reactive with either themselves (“self-crosslinking”) or a crosslinker, discussed below. Suitable film-forming resins include, for example, acrylic polymers, polyester polymers, polyurethane polymers, polyamide polymers, polyether polymers, polysiloxane polymers, polyepoxy polymers, epoxy resins, vinyl resins, copolymers thereof, and mixtures thereof. Generally, these polymers can be any polymers of these types made by any method known to those skilled in the art. The functional groups on the film-forming resins can include, for example, carboxylic acid groups, amine groups, epoxide groups, hydroxyl groups, thiol groups, carbamate groups, amide groups, area groups, isocyanate groups (including blocked isocyanate groups), mercaptan groups, and combinations thereof. Mixtures of film-forming resins can also be used in the preparation of the present film forming component.

The film forming component can be a thermoplastic coating composition and can include film-forming polymers, such as thermoplastic olefins such as (meth) acrylates, polyethylene, polypropylene, polybutene, thermoplastic urethane, polycarbonate, acrylonitrile-based materials, or condensation polymers, nonlimiting examples including polyesters and polyamides such as nylon, and the like.

The retroreflective powder coating composition may comprise an amount of film forming resin from 20 wt. %, 30 wt. %, 40 wt. % or 50 wt. % to 60 wt. % to 70 wt. %, 80 wt. %, or 90 wt. %, or any range using any two of the foregoing values, such as 20 to 90 wt. %, 30 to 80 wt. %, 40 to 70 wt. %, or 50 to 60 wt. %, wherein wt. % is based on the total weight of the retroreflective powder coating composition.

i. Crosslinker

A crosslinker may be used to react with the film forming resin. The crosslinker may have two or more reactive functional groups are capable of linking two or more monomers or polymers through chemical bonds.

Suitable crosslinkers may include phenolic resins, amino resins, epoxy resins, triglycidyl isocyanurate, hydroxyalkyamide, glycidyl functional acrylic copolymer, beta-hydroxy (alkyl) amides, alkylated carbamates, (meth)acrylates, isocyanates, blocked isocyanates, polyacids, anhydrides, organometallic acid-functional materials, polyamines, polyamides, aminoplasts, carbodiimides, oxazolines, cycloaliphatic polyuretdione, and combinations thereof. The blocked isocyanate crosslinker may comprise an internally blocked isocyanate (e.g., a uretdione). The blocked isocyanate may comprise an isocyanate blocked with an external blocking agent.

The film forming resin may comprise various types of base resins and crosslinkers including any of the base resins and crosslinkers previously described. The film forming resin may comprise a carboxylic acid functional polyester base resin and an epoxy functional addition polymer crosslinker. Alternatively, the film forming resin may comprise a hydroxyl functional polyester base resin and a blocked isocyanate crosslinker. Alternatively still, the film forming resin may comprise a polyester base resin and at least one crosslinker selected from a triglycidyl isocyanurate crosslinker, a hydroxyalkylamide crosslinker, a glycidyl functional acrylic copolymer crosslinker, and a combination thereof.

### B. Retroreflective Particles

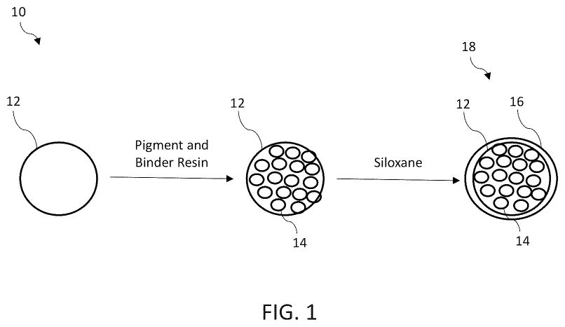

The retroreflective powder coating further comprises retroreflective particles. As seen in FIG. 1, the retroreflective particles 18 may include a base particle with a metallic coating 12, a pigment coating 14, and a siloxane coating 16. At least some of the particles provide retroreflective properties. That is, at least some of the particles reflect incident light back in the direction of the light source distributing incident light.

The retroreflective powder coating composition may comprise an amount of retroreflective particles from 20 wt. %, 25 wt. %, or 30 wt. % to 35 wt. %, 40 wt. % or 45 wt. %, or any range using any of the foregoing values as endpoints, such as 20 wt. % to 45 wt. %, 25 wt. % to 40 wt. %, or 30 wt. % to 35 wt. %, based on the total weight of the retroreflective powder coating composition.

i. Base Particle with Metallic Coating

The retroreflective particles include a base particle 12. The base particle 12 may be glass particles, such as glass microspheres. The glass particles may be at least partially coated with a metallic material. Suitable glass particles may include barium titanate glass spheres, borosilicate glass spheres, soda-lime glass spheres, and combinations thereof. Other suitable base particles may include particles at least partially made from other types of clear glass and/or silica.

The base particles 12 may be selected such that at least some of the particles are at least partially coated with a metallic material to provide desired retroreflective properties. A suitable metallic coating used to coat the particles may be aluminum. The metallic coating can be hemispherically coated over the particles. That is, the metallic coating can be coated over at least half, but not the entire, surface of the particles. The base particles may comprise particles that are hemispherically coated with aluminum. Metallic coated base particles are included in at least a portion of the retroreflective particles.

It is appreciated that the plurality of base particles 12 can comprise a mixture of different types of particles such as different types of glass particles. The plurality of base particles may comprise a combination of barium titanate glass particles at least partially coated with a metallic material (e.g. aluminum) and soda lime glass particles.

The base particles 12 may also be treated with an additional material that lowers the surface energy of the particles. The base particles coated with the metallic coating as previously described may be further coated with an additional material that lowers the surface energy below the surface tension of the binder materials (e.g. the film-forming resin and/or optional crosslinker) when in the molten state during the curing process, and optionally below the surface energy and/or surface tension of other components that may be in the coating composition.

As used herein, “surface energy” refers to the physical property equal to the amount of force per unit area necessary to expand the surface of a liquid. Although numerically equivalent of liquid surface tension, surface energy is used to describe a solid. Whether the additional material lowers the surface energy of the particle can be determined by measuring surface energy according to ASTM D7490-13 using a Kruss DSA100 analyzer. For instance, the plurality of base particles may comprise glass particles, such as barium titanate glass particles, hemispherically coated with a metallic material and at least partially coated with an additional material, such as an organic material.

In addition to the base particles 12, the retroreflective particles 18 may include base particles 12 that are not coated with a metallic material or an additional material that lowers a surface energy of the particles. Such particles may comprise glass particles, such as glass microspheres. The glass microspheres may comprise soda lime glass microspheres. The inclusion of such particles may further enhance the retroreflectivity of the coating.

The various types of base particles described herein can comprise various shapes and sizes. For instance, the particles can comprise microspheres. The particles can also comprise a particle size from 1 μm, 10 μm, or 100 μm to 200 μm, 300 μm, or 500 microns, or any range using any of the foregoing values as endpoints, such as 1 μm to 500 μm, 10 μm to 300 μm, or 100 μm to 200 μm, as determined by visually examining a micrograph of a transmission electron microscopy (“TEM”) image, measuring the diameter of the particles in the image, and calculating the particle size of the measured particles based on magnification of the TEM image.

The retroreflective particles may comprise an amount of base particles from 60wt. %, 65 wt. %, or 70 wt. % to 75 wt. %, 80 wt. % or 90 wt. %, or any range using any of the foregoing values as endpoints, such as 60 wt. % to 90 wt. %, 65 wt. % to 80 wt. %, or 70 wt. % to 75 wt. %, based on the total weight of the retroreflective particles.

ii. Pigment Coating Composition

The retroreflective particles 18 may comprise a pigment coating composition 14 including a binder resin, an organic pigment, and a solvent.

The pigment coating composition may have a number average particle size of up to 10 nm, up to 20 nm, up to 40 nm, up to 60 nm, up to 80 nm, up to 100 nm, or any range using any of the foregoing values as endpoints, such as 10 nm to 100 nm, 20 nm to 80 nm, or 40 nm to 60 nm, as determined by visually examining a micrograph of a transmission electron microscopy (“TEM”) image, measuring the diameter of the particles in the image, and calculating the particle size of the measured particles based on magnification of the TEM image. Suitable pigment coating compositions may include Andaro®-green, Andaro®-yellow, and MACROLEX® Green 5B FG.

The retroreflective particles may comprise an amount of pigment coating composition from 0.1 wt. %, 0.5 wt. %, or 1 wt. % to 2 wt. %, 5 wt. % or 10 wt. %, or any range using any of the foregoing values as endpoints, such as 0.1 wt. % to 10 wt. %, 0.5 wt. % to 5 wt. %, or 1 wt. % to 2 wt. %, based on the total weight of the retroreflective particles.

a. Pigment Binder Resin

The pigment coating composition may comprise a pigment binder resin that holds the components of the pigment coating composition together. The pigment binder resin may comprise a copolymer resin such as an acrylic, an epoxy, a polyurethane, a polyester, or combination of the foregoing.

A suitable pigment binder resin may comprise an acrylic copolymer having a molecular weight from 1000 Daltons, 5000 Daltons, or 10000 Daltons to 12500 Daltons, 15000 Daltons, or 20000 Daltons, or any range using any of the foregoing values as endpoints such as 1000 Daltons to 20000 Daltons, 5000 Daltons to 15000 Daltons, or 10000 Daltons to 12500 Daltons, as determined by Gel Permeation Chromatography (GPC) using polystyrene standards.

The pigment coating may comprise an amount of pigment binder resin from 10wt. %, 15 wt. %, or 20 wt. % to 25 wt. %, 30 wt. % or 35 wt. %, or any range using any of the foregoing values as endpoints, such as 10 wt. % to 35 wt. %, 15 wt. % to 30 wt. %, or 20 wt. % to 25 wt. %, based on the total weight of the pigment coating composition.

b. Organic Pigment

The pigment coating composition may comprise an organic pigment. The organic pigment may be any suitable pigment for coating the retroreflective particle, such as Pigment Green 36, Pigment Yellow 138, Pigment Yellow 139, Pigment Red 179, Pigment Red 202, Pigment Violet 29, Pigment Blue 15:3, azo (monozao, diszao, β-naphthol, naphthol AS, salt type (lakes), benzimidazalone, condensation, metal complex, isoindolinone, isoindoline) and polycyclic (phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone) pigments, and combinations of the foregoing.

The pigment coating composition may comprise an amount of organic pigment from 1 wt. %, 2 wt. %, or 5 wt. % to 7 wt. %, 10 wt. % or 15 wt. %, or any range using any of the foregoing values as endpoints, such as 1 wt. % to 15 wt. %, 2 wt. % to 10 wt. %, or 5 wt. % to 7 wt. %, based on the total weight of the pigment coating composition.

c. Solvent

The pigment coating composition may comprise a solvent such as water or an organic solvent. Suitable organic solvents may include butyl acetate, isopropanol, ethanol, xylene, toluene, methanol, methyl ethyl ketone, methyl isobutyl ketone, methoxy propyl acetate, and mixtures thereof.

The pigment coating composition may comprise an amount of solvent from 50 wt. %, 55 wt. %, or 60 wt. % to 65 wt. %, 70 wt. % or 75 wt. %, or any range using any of the foregoing values as endpoints, such as 50 wt. % to 75 wt. %, 55 wt. % to 70 wt. %, or 60 wt. % to 62 wt. %, based on the total weight of the pigment coating composition.

iii. Siloxane Coating

The retroreflective particles 18 may comprise a substantially transparent or translucent siloxane coating 16. The siloxane coating 16 may be a siloxane resin, such as a silicone-modified polymer. As used herein, a “substantially transparent coating” refers to a coating having a visible light transmittance of 60% or greater. As used herein, a “translucent coating” refers to a coating having a visible light transmittance of greater than 0% to less than 60%. By contrast, an “opaque coating” would refer to a coating having a visible light transmittance of 0%.

The silicone resin may be an organosiloxane-based polymer, such as a methyl silicone resin, phenyl silicone resin, or methyl-phenyl silicone resin, which are typically thermoset compositions capable of providing a range of mechanical characteristics, ranging from soft and rubbery to hard and brittle.

The siloxane coating 16 may comprise at least one siloxane monomer grafted onto a polymer. The siloxane monomer, such as an organoalkoxysilane, may be grafted onto a free hydroxy group of a polymer. Suitable polymers may include acrylic polymers, epoxy polymers, and polyurethane polymers, as well as polyester polymers.

Suitable organoalkoxysilanes may be of the following formula:

RₓSi(OR′)₄₋ₓ

wherein R is one or more moieties chosen independently from linear, branched, or cyclic alkyl and aryl, including cyclohexyl and/or phenyl; R′ is methyl, ethyl, propyl or alkyl; and x is 0, 1, 2, or 3.

The degree of crosslinking may in turn be dependent upon the nature of the siloxane monomer, or organosiloxane unit, used in the composition. As shown in the table below, organosiloxanes may be described according to the degree of oxygen substitution, or functionality, on the central silicone.

TABLE 1
Organosiloxane Oxygen Substitution

| Structural formula | Functionality | Symbol |
|---|---|---|
| R₃Si—O— | Monofunctional | M |
| 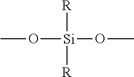 | Difunctional | D |
| 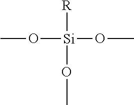 | Trifunctional | T |
| 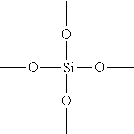 | Tetrafunctional | Q |

Generally, compositions including higher fractions of T (trifunctional) and Q (tetrafunctional) units display higher degrees of crosslinking.

R may be C6 aryl or a linear or branched alkyl having from as few as 1, 2, 3, or as many as 4, 5, 6, or more carbon atoms, or a number of carbon atoms in any other range combination using these endpoints. R may be selected from methyl, ethyl, propyl, and phenyl. Suitable values for x may be at least 1 and less than 4.

The organoalkoxysilane may comprise at least one organoalkoxysilane selected from methyltrimethoxysilane, methyltriethoxysilane, dimethyldiethoxysilane, dimethyldimethoxysilane, trimethylmethoxysilane, trimethylethoxysilane, phenyltrimethoxysilane, phenyl triethoxysilane, cyclohexyltrimethoxy silane, or combinations of the foregoing.

The organoalkoxysilane may be a functionalized siloxane, such as 3-aminopropyltriethoxysilane, (3-glycidoxypropyl)trimethoxysilane, and allyltrimethoxysilane. One suitable organoalkoxysilane is RSN-5314 resin, available from Dow Corning of Midland, MI.

Other suitable silicone materials are silanes having the following formula:

[RSiO3/2]ₙ.

The siloxane coating 16 may comprise functional groups such as amine, alkoxy, hydroxy, other suitable functional groups, and combinations of the foregoing. The siloxane coating 16 may have a variety of ratios of M, D, T, and Q functionalities. A suitable siloxane coating may be an amine and alkoxy/hydroxy functional silicone of Formula (I):

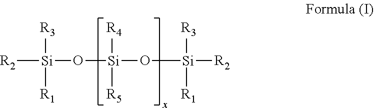

wherein R₁ could be —OCH₃, —OCH₂CH₃, —OCH₂CH₂CH₃, —(CH₂)₁₋₆CH₃, —OH, —CH₃, —Ph, —CH₂CH₃, —NH₂, —(CH₂)₃NH(CH₂)₂NH₂, —CH═CH₂;
R₂ could be —OCH₃, —OCH₂CH₃, —OCH₂CH₂CH₃, —OH, —CH₃, —CH₂CH₃, —Ph, —NH₂, —SH, —CH═CH₂;
R₃ could be —OCH₃, —OCH₂CH₃, —OCH₂CH₂CH₃, —OH, —CH₃, —CH₂CH₃, —Ph, —NH₂, —SH, —CH═CH₂;
R₄ could be —(CH₂)₃NH₂, —(CH₂)₃OH, —(CH₂)₃SH, —CH₂CHPhCH₃, —C₁₂H₂₅, —H, —CH₃, —Ph, —CH₂CH₃, —CH═CH₂;
R₅ could be —(CH₂)₃NH₂, —(CH₂)₃OH, —(CH₂)₃SH, —CH₂CHPhCH₃, —C₁₂H₂₅, —H, —CH₃, —Ph, —CH₂CH₃, —CH═CH₂; and
x is the number of siloxane units ranging from 30 to 60 units.

The silicone coating of Formula (I) may have amine functionality at least one of the terminal ends of the siloxane, between the silicone back bones comprising siloxane monomers, or a combination thereof.

The siloxane coating may have a molecular weight of silicone from 500 amu, 1000 amu, or 5000 amu to 7000 amu, 9000 amu, or 10000 amu, or any range using any of the foregoing values as endpoints, such as 500 amu to 10000 amu, 1000 amu to 9000 amu, or 5000 amu to 7000 amu, as measured using gel permeation chromatography (GPC) using polystyrene standards.

The retroreflective particles may comprise an amount of siloxane coating from 0.1 wt. %, 0.5 wt. %, or 1 wt. % to 2 wt. %, 5 wt. % or 10 wt. %, or any range using any of the foregoing values as endpoints, such as 0.1 wt. % to 10 wt. %, 0.5 wt. % to 5 wt. %, or 1 wt. % to 2 wt. %, based on the total weight of the retroreflective particles.

### III. Method of Producing Retroreflective Powder Coating Composition

The retroreflective powder coating composition described above may be produced by applying the liquid pigment coating composition comprising the binder resin and organic pigment over at least a portion of base particles, such as metallic coated base particles, creating the colored or pigmented retroreflective particles; and mixing the retroreflective particles with the film forming resin.

A base powder composition may be formulated by weighing each amount of the film forming resin, pigment crosslinker, and additives into a vessel and agitating the vessel for at least 10 sec., at least 30 sec., at least 60 sec., at least 120 sec., at least 200 sec. or any range using any of the foregoing values as endpoints, such as 10 to 200 sec., or 30 to 60 sec.

Once the components are thoroughly mixed, the homogenous base powder mixture may be heated and extruded in a combined heating extrusion processes. A screw-type extruder (e.g., a twin-screw extruder) can be used, which may include multiple heating zones that progressively heats the components of the powder coating mixture to a desired temperature. The extruder may include at least two different heating zones, where the first heating zone heats the powder coating mixture to 50° C. to 70° C., softening the mixture. The second heating zone may heat the softened mixture to 60° C. to 150° C., holding the mixture at the desired temperature for a given resonance time.

The twin-screw extruder may extrude the composition using a moderate screw configuration and speed of 200 RPM, 300 RPM, or 400 RPM to 500 RPM, 800 RPM, or 1000 RPM, or any range using any of the foregoing values as endpoints, such as 200 to 1000 RPM, 300 to 800 RPM, or 400 to 500 RPM, and a feed rate such that a torque of 30-35% is observed on the equipment.

The extruded composition may be chilled on rollers to solidify the composition into solid chips. The cooled composition may be considered at least partially cured. Once cooled, the solid composition may have a diameter greater than desired for powder coating applications, and thereafter, the size of the solid powder coating material may be reduced, such as by a pulverization or grinding process. Once the particle size is reduced, the particles may be milled to a desired particle size diameter, such as milled via an air milling process (e.g., a Mikro ACM®-1 Air Classifying Mill) with a desired mesh, resulting in a targeted powdered particle diameter size distribution. For instance, the powder coating material may be milled with/classified with a mesh anywhere from 50 mesh to 1000 mesh, resulting in an average particles size (e.g., a D97 value) ranging from 30 μm, 32 μm, or 34 μm to 36 μm, 38 μm, or 40 μm, or any range using any of the foregoing values as endpoints. The diameter of the powder coating particle may be tuned based upon a variety of parameters including how the powder coating is applied, such as if the powder coating composition is applied in a thermal application process to a metal substrate, in a thermal application process to a plastic/composite substrate, and/or electrostatically applied to an electrically conductive substrate.

To form the retroreflective particles, a liquid siloxane overlayer coating can be applied to the colored/pigmented retroreflective particles under ambient conditions (20-25° C.) followed by thermal exposure to obtain a free-flowing powder of retroreflective particles. As used herein, free-flowing means that the retroreflective particles do not stick to each other. Thermal exposure temperatures may range from 100° C. to 200° C. and can be regulated by employing a curing catalyst such as sirconium alkoxide and organotin catalyst.

The silicone coated colored/pigmented retroreflective particle powder may be combined with the film forming resin comprising a base resin, a cross linker, and additives, such as pigments. Each of the base powder composition and the retroreflective particles may of the coating composition may be added to the mixing process in a dry state, a semi-dry state, and/or a liquid state.

### C. Additives

The retroreflective powder coating composition may comprise a variety of additives such as pigments, blocking agents, surface agents, flow agents, leveling control agents, plasticizers, and any other suitable additives.

The retroreflective powder coating composition may comprise a further pigment that is different from the retroreflective particles in an amount from 10 wt. %, 15 wt. %, or 20 wt. % to 30 wt. %, 40 wt. %, or 50 wt. %, or any range using any two of the foregoing values, such as 10 to 50 wt. %, 15 to 40 wt. %, or 20 to 30 wt. %, wherein wt. % is based on the total weight of the retroreflective powder coating composition.

The retroreflective powder coating composition may comprise a total amount of additives from 20 wt. %, 30 wt. %, 40 wt. %, or 50 wt. % to 60 wt. %, 70 wt. %, 80 wt. %, or 90 wt. %, or any range using any two of the foregoing values, such as 20 to 90 wt. %, 30 to 80 wt. %, 40 to 70 wt. %, or 50 to 60 wt. %, wherein wt. % is based on the total weight of the retroreflective powder coating composition.

### IV. Application of Retroreflective Coating

The retroreflective powder coating composition may be applied by any means standard in the art, such as thermal spraying, electrostatic spraying, and the like. The retroreflective powder coating composition may be a curable coating composition such that at least a portion of the components that make up the coating composition are polymerizable and/or crosslinkable including self-crosslinkable polymers.

### A. Application Process

i. Electrostatic Powder Spraying

The retroreflective powder coating composition may be applied using electrostatic powder spraying. Electrostatic spraying may include the coating composition being applied in a powder recovery booth to an electrically conductive substrate, where an electrical charge has been applied to the powder particles therefore attracting the charged powder particles to the surfaces of the substrate. The electrically conductive substrate can be preheated prior to powder application (e.g., to increase the bonding of the powder coating particles to the surface of the substrate) and/or post-baked after the application of the powder (e.g., to initiate the reaction(s) necessary to form a polymeric coating on the substrate) to cure the coating composition.

The coating composition may be cured by post-baking at a temperature from 200° C., 250° C., or 300° C. to 350° C., 375° C., or 400° C., or any range using any two of the foregoing values as endpoints, such as 200° C., to 400° C., 250° C. to 375° C., or 300° C. to 350° C.

During electrostatic spraying, the retroreflective coating particles are sprayed in a powdered state. An electrostatic gun may spray the charged powdered coating composition onto the substrate. The electrostatic gun may have a round spray nozzle/tip or a flat spray nozzle/tip. The electrostatic spray gun may spray the powder coating mixture at a variety of pressures, which may adjusted to achieve a desired powder coating finish and/or effect. The powder coating mixture may be sprayed at about 1 psig or greater, about 5 psig or greater, at about 20 psig or greater, at about 25 psig or greater, at about 30 psig or greater or about 40 psig or less, at about 50 psig or less, about 60 psig or less, or any value encompassed by these endpoints.

The electrostatic gun may comprise at least one electrode and a high-voltage generator. The high-voltage generator may generate a negative polarity to be applied to the electrode during application of the powder coating composition. The high-voltage generator can generate a negative polarity voltage of about 0 KV or greater, about 1 KV or greater, about 10 KV or greater, about 20 KV or greater, about 30 KV or greater, about 40 KV or greater, about 50 KV or less, about 60 KV or less, about 70 KV or less, about 80 KV or less, about 90 KV of less, about 100 KV or less, or any value encompassed by these endpoints.

Excess powder particles that do not adhere during the spraying may be collected in a recovery booth and recycled using processing equipment. Additionally, in the case of thermoplastic powder coatings, since the particles are applied to the substrate in a raw powder state, post-baking of the applied powder is often needed to initiate coalescence of the powder coating particles to form the resulting thermoplastic layer on the substrate. This often necessitates the use of curing oven(s). The powder booth equipment and/or the curing oven physical dimensions may also impose size limitations on the substrate (e.g., limited only to a small enough size to fit in the equipment) which often also limits the powder application only to disassembled individual parts (e.g., not being able to be applied to fully constructed components). Finally, in the case where a second layer of a coating is required, the substrate may pass through substantially the same powder coating process for a second time.

ii. Thermal Spraying

The coating composition may be applied via thermal spraying. To thermal spray the coating composition onto a substrate, the powder coating composition may be heated to an application temperature which at least partially melts/softens the powder particles in the presence of a carrier gas (e.g., air, inert gas, etc.). The coating composition may be heated to an application temperature from 100° C., 125° C., or 150° C. to 175° C., 200° C., or 235° C., or any range using any two of the foregoing values as endpoints, such as 100° C. to 225° C., 125° C. to 200° C., or 150° C., or 175° C.

In the case of thermoset powder coatings, the pre-heating may initiate the chemical reaction(s) necessary (e.g., crosslinking, partial/full curing, etc.) to form the coating once applied to the substrate. The melted/softened powder particles are accelerated with the gas stream and deposited onto the substrate in a splattering pattern. The resulting coating cures on the substrate which may, but not necessarily, be accomplished in a post baking process (e.g., as based upon the curing requirements of the coating). Subsequent layer(s) of the same, or different, coating formulations can be applied to the first layer to form a multi-layer coating stack up. For instance, the first powder coating composition can be applied as a base/primer layer, and the next layer can be applied on top of the primer layer after the first layer at least partially cures, resulting in a two-layer coating stack up.

### B. Substrates

Suitable substrates for application of the retroreflective powder coating composition may be metallic or non-metallic. Metallic substrates may include, but are not limited to, tin, steel, cold rolled steel, hot rolled steel, steel coated with zinc metal, zinc compounds, zinc alloys, electrogalvanized steel, hot-dipped galvanized steel, galvanealed steel, galvalume, steel plated with zinc alloy, stainless steel, zinc-aluminum-magnesium alloy coated steel, zinc-aluminum alloys, aluminum, aluminum alloys, aluminum plated steel, aluminum alloy plated steel, steel coated with a zinc-aluminum alloy, magnesium, magnesium alloys, nickel, nickel plating, bronze, tinplate, clad, titanium, brass, copper, silver, gold, 3-D printed metals, cast or forged metals and alloys, or combinations thereof.

Non-metallic substrates may include polymeric, plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (PET), polycarbonate, engineering polymers such as poly(etheretherketone) (PEEK), polycarbonate acrylobutadiene styrene (PC/ABS), polyamide, wood, veneer, wood composite, particle board, medium density fiberboard, cement, stone, glass, paper, cardboard, textiles, leather both synthetic and natural, composite substrates such as fiberglass composites or carbon fiber composites, 3-D printed polymers and composites, and the like.

### C. Monocoat and Multilayer System Application

The coating composition can be applied to a substrate to form a monocoat. As used herein, a “monocoat” refers to a single layer coating system that is free of additional coating layers. Thus, the coating composition can be applied directly to a substrate and cured to form a single layer coating, i.e. a monocoat. When the retroreflective powder coating composition may be applied to a substrate to form a monocoat, the coating composition can include additional components to provide other desirable properties. The retroreflective powder coating composition may also include an inorganic component that acts as a corrosion inhibitor. As used herein, a “corrosion inhibitor” refers to a component such as a material, substance, compound, or complex that reduces the rate or severity of corrosion of a surface on a metal or metal alloy substrate. The inorganic component that acts as a corrosion inhibitor can include, but is not limited to, an alkali metal component, an alkaline earth metal component, a transition metal component, or combinations thereof.

Alternatively, the retroreflective powder coating composition can be applied over a first coating layer deposited over a substrate to form a multi-layer coating system. Each layer of a multi-layer system may be applied using electrostatic spraying, thermal spraying, or any other suitable application method. A coating composition may be applied to a substrate as a primer layer and the retroreflective powder coating composition may be applied over the primer layer as a topcoat. As used herein, a “primer” refers to a coating composition from which an undercoating may be deposited onto a substrate in order to prepare the surface for application of a protective or decorative coating system. A basecoat can also be used with the multi-layer coating system. A “basecoat” refers to a coating composition from which a coating is deposited onto a primer and/or directly onto a substrate, optionally including components (such as pigments) that impact the color and/or provide other visual impact, and which may be overcoated with the retroreflective powder coating previously described. A clearcoat layer may be applied over the retroreflective coating layer formed from the retroreflective powder coating composition for further improved weatherability and/or durability of the coated substrate.

### D. Applications of the Retroreflective Coating

The retroreflective coating may be applied to a variety of surfaces to provide reflective properties. The coating may be used to add reflectiveness to paint/coatings for machinery, signs, road markings, vehicles, and other suitable uses that may require reflective properties.

### V. Properties of the Retroreflective Coating

### A. Dry Film Thickness (DFT)

Dry film thickness (DFT) is the thickness of a coating as measured above the substrate. The coating composition can be a single layer or multiple layers.

The coatings formed from the coating compositions of the present invention can be applied to a substrate such that the cured coating has a dry film thickness of 20 to 1000 microns, 30 to 300 microns, or 50 to 150 microns, as measured by measured using a TM-114A Electronic Gauge.

The dry film thickness may be larger than a diameter of the particles and additional particles such that the particles and additional particles do not protrude from the dry film layer.

### A. Coefficient of Retro-Reflection

The coefficient of retroreflection (RA) may be measured using a retroreflectometer according to ASTM E1709-08 at a 0.2 degree observation angle and entrance angle of −4°.

The retroreflective powder coating composition may have a RA of 6 cd/ft/ft2, 8 cd/ft/ft2, or 10 cd/ft/ft2 to 12 cd/ft/ft2, 14 cd/ft/ft2, or 16 cd/ft/ft2, or any range using any of the foregoing values, such as 6 cd/ft/ft2 to 16 cd/ft/ft2, 8 cd/ft/ft2 to 14 cd/ft/ft2, or 10 cd/ft/ft2 to 12 cd/ft/ft2, as measured using a retroreflectometer according to ASTM E1709-08 at a 0.2 degree observation angle and entrance angle of −4°.

### B. Maximum Haze

The haze attributed to the pigment can be measured by starting with the pigment in a resin dispersed state and diluting the dispersion with compatible solvent and placing the dilution in an optical transmission measurement cell with 500 micron path length. The percent haze of the liquid in the cell is measured according to ASTM D1003 using an integrating sphere, such as an X-Rite Ci7800. When the haze is measured, the pigment dilution is such that the percent transmittance at the wavelength on maximum extinction is about 17.5%. An acceptable haze may be achieved for relatively large particles when the difference in refractive index between the particles and the surrounding medium is low. Conversely, for smaller particles, greater refractive index differences between the particle and the surrounding medium may provide an acceptable haze.

The pigment coating composition may impart a maximum haze from 1%, 2%, or 4% to 6%, 8%, or 10%, or any range using the foregoing values as endpoints, such as 1% to 10%, 2% to 8%, or 4% to 6%, as measured according to ASTM D1003.

### C. Glass Plate Flow

Glass Plate Flow may be determined according to ASTM D4242-07.

To test the glass plate flow of a liquid coating composition, a pellet of the press molded composition may be placed on a preheated level glass plate in an oven at 300 oF (149 oC.). After the door is closed for 1 minute, the glass plate may be tilted up to an angle of 65 o. After an additional 29 minutes in the oven, the glass plate may be removed, and the length of flow may be measured.

The coating composition of the present disclosure may have a glass plate flow from 10 mm, 15 mm, or 20 mm to 25 mm, 30 mm, or 35 mm, or any range using any two of the foregoing values as endpoints, such as 10 to 35 mm, 15 to 30 mm, or 20 to 25 mm.

### EXAMPLES

Aspects of the present disclosure are further illustrated by reference to the following examples. It will be apparent to those skilled in the art that many modifications, both to materials, and methods, may be practiced without departing from the scope of the disclosure.

### Example 1 Retroreflective Beads Functionalized with Green Pigment And Low Surface Energy Overlayer

### Surface Functionalization of Glass Beads

In a plastic cup (4 oz/118.29 mL), metallized PRIZMALITE P2453BTA glass beads (100 g; Hemispherical Aluminum coated barium titanate glass microspheres commercially available from Prizmalite New York) were functionalized with 2 g of Andaro®-green pigment, commercially available from PPG Industries (Andaro® is a registered trademark of PPG Industries Ohio, Inc.) by a dropwise addition of the pigment under stirring condition (200 RPM). After complete addition of Andaro®-green pigment, the mixture was dried by spreading it on a tray either in ambient condition (1 hour) or at 100° C. for 15 min. Then, Andaro®-green functionalized glass beads were treated with functional polysiloxane (GP-657; commercially available from Genesee Polymer) to create a low surface energy overlayer coating on glass beads. To do the same, functional polysiloxane (0.15 g) was added to the Andaro®-green treated beads in a stepwise manner under stirring condition. Eventually, the treated bead powder was dried by spreading it on a tray at 200° C. for 2 hours.

### Evaluation of Surface Functionalized Beads

Surface functionalized beads were evaluated by two methods: (i) Solvent resistance and (ii) Floatation test.

Solvent resistance:

To evaluate the migration stability of green pigment from the glass bead surface, glass beads (1 g) functionalized by dual-overlayer of Andaro®-green pigment and functional polysiloxane was immersed in acetone solvent (10 g). Insignificant green color was observed in the acetone solvent (Rating 4; see Table 2) which demonstrate robust functionalization of glass beads.

TABLE 2
Migration Stability of Green Pigment From Glass Bead Surface

| Rating | Description |
|---|---|
| 0 | The acetone solvent instantaneously turned green |
| | upon immersion of glass beads |
| 1 | The acetone solvent slowly turned green upon |
| | immersion of glass beads (after 1-2 min) |
| 2 | The acetone solvent slowly turned green upon |
| | immersion of glass beads (After 4-5 min) |
| 3 | The acetone solvent slowly turned green upon |
| | immersion of glass beads (After 25-30 min) |
| 4 | Insignificant green coloration observed (After 24 h) |

### Floatation Test:

To evaluate the hydrophobicity of functionalized glass bead, 1 g of functional glass beads (coated with dual-overlayer of Andaro®-green pigment and functional polysiloxane) was placed on the surface of water filled beaker (100 g). The glass beads remain floating for >24 h and beyond (Rating 4; see Table 3).

TABLE 3
Hydrophobicity of Functionalized Glass Beads

| Rating | Description |
|---|---|
| 0 | Functionalized glass beads instantaneously sink in water |
| 1 | 75% of the total functionalized glass beads |
| | instantaneously sink and 25% remains floating |
| 2 | 50% of the total functionalized glass beads instantaneously |
| | sink and 50% remains floating |
| 3 | 25% of the total functionalized glass beads instantaneously |
| | sink and 75% remains floating |
| 4 | Functionalized glass beads remain floating initially but |
| | sinks overtime (after 1 h) |
| 5 | Functionalized beads remain floating indefinitely |

Powder Coating with Surface Functionalized Beads:

Milled powder pigment mixtures were prepared as described below.

Part A: Milled powder pigment mixtures were first prepared from the components listed in Table 4. The base powder coating composition had a Glass Plate Flow of 26 mm as determined according to ASTM D4242-07.

TABLE 4
Base Powder Coating Composition

| Component | Amount (g) |
|---|---|
| TIONA 596¹ | 400 |
| CRYLCOAT 2890-0² | 300 |
| POLYMAC 3110³ | 96 |
| CRELAN EF403⁴ | 204 |

¹A titanium dioxide pigment, commercially available from Cristal Global (Jeddah, Saudi Arabia)
²A hydroxylated polyester resin, commercially available from Allnex (Frankfurt, Germany).
³A hydroxyl terminated polyester resin, commercially available from Polynt Composites (Scanzorosciate, Italy).
⁴A cycloaliphatic polyuretdione, commercially available from Covestro (Leverkusen Germany).

Each of the components listed in Table 4 was weighed in a plastic bag and mixed by shaking vigorously in the same plastic bag for 30 seconds to form a dry homogeneous mixture. The mixture was melt mixed in a Theysohn 30 mm twin screw extruder with a moderately aggressive screw configuration and a speed of 500 RPM. The first extruder zone was set at 50° C., and the second zone was set to 100° C. The feed rate was such that a torque of 30-35% was observed on the equipment. The mixtures were dropped onto a set of chill rolls to cool and re-solidify the mixtures into solid chips. The chips were milled using a coffee grinder and sieved through a 104-micron screen to obtain a mass median diameter particle size of 35-40 microns. The resulting coating compositions were solid particulate powder coating compositions that were free flowing. The Glass Plate Flow was measured per the procedure described above on the relevant examples. As a final step, the free-flowing powder coating composition was vigorously mixed with PRIZMALITE P2453BTA, functionalized in “Surface Functionalization of Glass Beads,” in a plastic bag. The final coating composition was applied using electrostatic powder spraying on aluminum Q-panel substrate and cured at 190° C. for 20 minutes. The coefficient of retro-reflection (RA) was measured at 11+1 cd/ft/ft².

TABLE 5
Final Retroreflective Powder Composition

| Component | Amount (g) |
|---|---|
| Base powder composition Table 4 | 70 |
| PRIZMALITE P2453BTA functionalized in | 30 |
| Surface Functionalization of Glass Beads | |

### Example 2 Retroreflective Beads Functionalized with Yellow Pigment And Low Surface Energy Overlayer

### Surface Functionalization of Glass Beads

The surface functionalization of glass beads with Andaro® Yellow, a yellow pigment, was performed the same way as described in the section 1.1. except Andaro®-green pigment was replaced by Andaro® Yellow PY128 commercially available from PPG Industries (Andaro® is a registered trademark of PPG Industries Ohio, Inc.).

### Evaluation of Surface Functionalized Beads

Solvent resistance:

To evaluate the migration stability of green dye from the glass bead surface, glass beads (1 g) functionalized by dual-overlayer of Andaro® yellow and functional polysiloxane was immersed in acetone solvent (10 g). Insignificant yellow color was observed in the acetone solvent (Rating 4; see Table 2) which demonstrate robust functionalization of glass beads.

Floatation test:

To evaluate the hydrophobicity of functionalized glass bead, 1 g of functional glass beads (coated with dual-overlayer of Andaro® yellow pigment and functional polysiloxane) was placed on the surface of water filled beaker (100 g). The glass beads remain floating for >24 h and beyond (Rating 4; see Table 3).

Powder Coating with Surface Functionalized Beads:

The final coating fabrication using yellow PRIZMALITE P2453BTA, functionalized in “Surface Functionalization of Glass Beads”, was performed similar to the example 1. The coefficient of retro-reflection (RA) was measured at 9+1 cd/ft/ft².

### Example 3 Retroreflective Beads Functionalized with Green Dye and Low Surface Energy Overlayer

### Surface Functionalization of Glass Beads

The surface functionalization of glass beads with MACROLEX® Green 5B FG, a green dye, was performed the same way as described in Example 1 except Andaro®-green pigment was replaced by MACROLEX® Green 5B FG (commercially available from Lanexess, U.S.).

### Evaluation of Surface Functionalized Beads

Solvent resistance:

To evaluate the migration stability of green dye from the glass bead surface, glass beads (1 g) functionalized by dual-overlayer of MACROLEX® Green 5B FG and functional polysiloxane was immersed in acetone solvent (10 g). The acetone solvent instantaneously turned green upon immersion of glass beads (Rating 0; see Table 2). This demonstrates poor functionalization of beads compared to Andaro®-type pigment which will result migration of color from glass beads during flow and curing of coating leaving glass beads uncolored.

Floatation test:

The glass beads functionalized with MACROLEX® Green 5B FG followed by low surface energy siloxane coating exhibited similar hydrophobicity to the Andaro®-green functionalized beads i.e., remain indefinitely floated on the surface of water (Rating 4; see Table 3).

Wherein particular examples of this invention have been described above for purposes of illustration, it will be evident to those skilled in the art that numerous variations of the details of the present invention may be made without departing from the invention as defined in the appended claims. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

### ASPECTS

Aspect 1 is a retroreflective powder coating composition, comprising: a film-forming resin; and a plurality of retroreflective particles, each comprising: a base particle: a metallic coating disposed over at least a portion of the base particle; a pigment coating composition disposed over the metallic coating and/or the base particle, the pigment coating composition comprising: a binder resin; and an organic pigment; and a substantially transparent siloxane coating disposed over at least a portion of the pigment coating composition.

Aspect 2 is the composition of Aspect 1, wherein the binder resin is an acrylic copolymer having a weight average molecular weight from 1,000 to 20,000 Daltons as measured by gel permeation chromatography (GPC).

Aspect 3 is the composition of either Aspect 1 or Aspect 2, wherein the pigment coating composition comprises a plurality of nano-sized pigments having a number average particle size of up to 100 nm as measured using transmission electron microscopy (TEM) images.

Aspect 4 is the composition of any one of Aspects 1-3, wherein the film-forming resin comprises the reaction product of: a base resin selected from a polyester, an acrylic, an epoxy, a polyurethane, and combinations of the foregoing; and a crosslinker.

Aspect 5 is the composition of Aspect 4, wherein the film-forming resin comprises a carboxylic acid functional polyester, and the crosslinker comprises an epoxy functional addition polymer.

Aspect 6 is the composition of Aspect 4, wherein the film-forming resin comprises a hydroxyl functional polyester, and the crosslinker comprises a blocked isocyanate.

Aspect 7 is the composition of Aspect 4, wherein the base resin is a polyester, and the crosslinker is comprises a triglycidyl isocyanurate crosslinker, a hydroxyalkylamide crosslinker, a glycidyl functional acrylic copolymer crosslinker, or a combination thereof.

Aspect 8 is the composition of any one of Aspects 1-7, wherein the siloxane coating is an amine and alkoxy/hydroxy functional silicone having of the formula:

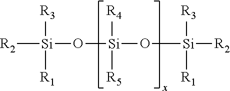

wherein R₁ could be —OCH₃, —OCH₂CH₃, —OCH₂CH₂CH₃, —(CH₂)₁₋₆CH₃, —OH, —CH₃, —Ph, —CH₂CH₃, —NH₂, —(CH₂)₃NH(CH₂)₂NH₂, —CH═CH₂;
R₂ could be —OCH₃, —OCH₂CH₃, —OCH₂CH₂CH₃, —OH, —CH₃, —CH₂CH₃, —Ph, —NH₂, —SH, —CH═CH₂;
R₃ could be —OCH₃, —OCH₂CH₃, —OCH₂CH₂CH₃, —OH, —CH₃, —CH₂CH₃, —Ph, —NH₂, —SH, —CH═CH₂;
R₄ could be —(CH₂)₃NH₂, —(CH₂)₃OH, —(CH₂)₃SH, —CH₂CHPhCH₃, —C₁₂H₂₅, —H, —CH₃, —Ph, —CH₂CH₃, —CH═CH₂;
R₅ could be —(CH₂)₃NH₂, —(CH₂)₃OH, —(CH₂)₃SH, —CH₂CHPhCH₃, —C₁₂H₂₅, —H, —CH₃, —Ph, —CH₂CH₃, —CH═CH₂; and
x is the number of siloxane units ranging from 30 to 60 units;
wherein the siloxane coating has a molecular weight of silicone of 500 amu to 10000 amu as measured by Gas Permeation Chromatography using polystyrene standards; and
wherein the amine functionality is located at one of a terminal end of the siloxane or in between of the silicone backbone.

Aspect 9 is the composition of any one of Aspects 1-8, wherein the retroreflective particles comprise from 20 wt. % to 45 wt. %, based on a total solids weight of the composition.

Aspect 10 is the composition of any one of Aspects 1-9, wherein the base particles comprise glass spheres selected from barium titanate glass spheres, borosilicate glass sphere, soda-lime glass sphere, and combinations of the foregoing.

Aspect 11 an article having a surface at least partially coated with a coating formed from the composition of any one of Aspects 1-10.

Aspect 12 is the article of Aspect 11, wherein the coating comprises a coefficient of retro-reflection (R_{A}) of at least 6 cd/ft/ft² as measured using a retroreflectometer with an entrance angle of −4° and an observation angle of 0.2° in accordance with ASTM E1709.

Aspect 13 is a method of coating an article, comprising: applying the composition of any one of claims 1 to 10 over at least a portion of a surface of the article; and curing the composition to form a coating, wherein the coating comprises a coefficient of retro-reflection (R_{A}) of at least 6 cd/ft/ft² as measured using a retroreflectometer with an entrance angle of −4° and an observation angle of 0.2° in accordance with ASTM E1709.

Aspect 14 a method for producing retroreflective particles for use in a powder coating composition, comprising: applying a liquid pigment coating composition comprising a binder resin, an organic pigment over at least portions of a plurality of retroreflective particles, each retroreflective particle comprising a base particle having a metallic coating disposed over at least a portion of the base particle, to form pigmented retroreflective particles; and applying a substantially transparent siloxane coating over the pigmented retroreflective particles.

Aspect 15 is the method of Aspect 14, further comprising the step of combining the pigmented retroreflective particles with a film-forming resin.

Aspect 16 is the method of either Aspect 14 or Aspect 15, wherein the liquid pigment coating composition comprises: binder resin in an amount from 15 to 35 wt. %; organic pigment in an amount from 5 to 15 wt. %; and solvent in an amount from 55 to 75 wt. %, based on a total weight of the pigment coating composition.

Aspect 17 is the method of any one of Aspects 14-16, wherein the organic pigment can impart maximum haze up to 10% as determined in accordance with ASTM D1003.

Aspect 18 is the method of any one of Aspects 14-17, wherein the organic pigment is selected from Pigment Green 36, Pigment Yellow 138, Pigment Yellow 139, Pigment Red 179, Pigment Red 202, Pigment Violet 29, Pigment Blue 15:3, azo (monozao, diszao, β-naphthol, naphthol AS, salt type (lakes), benzimidazalone, condensation, metal complex, isoindolinone, isoindoline) and polycyclic (phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone) pigments, and combinations of the foregoing.

What is claimed is:

1. A retroreflective powder coating composition, comprising:
a film-forming resin; and
a plurality of retroreflective particles, each comprising:
a base particle:
a metallic coating disposed over at least a portion of the base particle;
a pigment coating composition disposed over the metallic coating and/or the base particle, the pigment coating composition comprising:
a binder resin; and
an organic pigment; and
a substantially transparent siloxane coating disposed over at least a portion of the pigment coating composition.

2. The composition of claim 1, wherein the binder resin is an acrylic copolymer having a weight average molecular weight from 1,000 to 20,000 Daltons as measured by gel permeation chromatography (GPC).

3. The composition of claim 1, wherein the pigment coating composition comprises a plurality of nano-sized pigments having a number average particle size of up to 100 nm as measured using transmission electron microscopy (TEM) images.

4. The composition of claim 1, wherein the film-forming resin comprises the reaction product of:
a base resin selected from a polyester, an acrylic, an epoxy, a polyurethane, and combinations of the foregoing; and
a crosslinker.

5. The composition of claim 4, wherein the film-forming resin comprises a carboxylic acid functional polyester, and the crosslinker comprises an epoxy functional addition polymer.

6. The composition of claim 4, wherein the film-forming resin comprises a hydroxyl functional polyester, and the crosslinker comprises a blocked isocyanate.

7. The composition of claim 4, wherein the base resin is a polyester, and the crosslinker is comprises a triglycidyl isocyanurate crosslinker, a hydroxyalkylamide crosslinker, a glycidyl functional acrylic copolymer crosslinker, or a combination thereof.

8. The composition of claim 1, wherein the siloxane coating is an amine and alkoxy/hydroxy functional silicone having of the formula 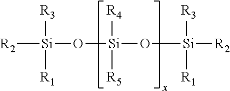
wherein R₁ could be —OCH₃, —OCH₂CH₃, —OCH₂CH₂CH₃, —(CH₂)₁₋₆CH₃, —OH, —CH₃, —Ph, —CH₂CH₃, —NH₂, —(CH₂)₃NH(CH₂)₂NH₂, —CH═CH₂;
R₂ could be —OCH₃, —OCH₂CH₃, —OCH₂CH₂CH₃, —OH, —CH₃, —CH₂CH₃, —Ph, —NH₂, —SH, —CH═CH₂;
R₃ could be —OCH₃, —OCH₂CH₃, —OCH₂CH₂CH₃, —OH, —CH₃, —CH₂CH₃, —Ph, —NH₂, —SH, —CH═CH;
R₄ could be —(CH₂)₃NH₂, —(CH₂)₃OH, —(CH₂)₃SH, —CH₂CHPhCH₃, —C₁₂H₂₅, —H, —CH₃, —Ph, —CH₂CH₃, —CH═CH₂;
R₅ could be —(CH₂)₃NH₂, —(CH₂)₃OH, —(CH₂)₃SH, —CH₂CHPhCH₃, —C₁₂H₂₅, —H, —CH₃, —Ph, —CH₂CH₃, —CH═CH₂; and
x is the number of siloxane units ranging from 30 to 60 units;
wherein the siloxane coating has a molecular weight of silicone of 500 amu to 10000 amu as measured by Gas Permeation Chromatography using polystyrene standards; and
wherein the amine functionality is located at one of a terminal end of the siloxane or in between of the silicone backbone.

9. The composition of claim 1, wherein the retroreflective particles comprise from 20 wt. % to 45 wt. %, based on a total solids weight of the composition.

10. The composition of claim 1, wherein the base particles comprise glass spheres selected from barium titanate glass spheres, borosilicate glass sphere, soda-lime glass sphere, and combinations of the foregoing.

11. An article having a surface at least partially coated with a coating formed from the composition of claim 1.

12. The article of claim 11, wherein the coating comprises a coefficient of retro-reflection (R_{A}) of at least 6 cd/ft/ft² as measured using a retroreflectometer with an entrance angle of −4° and an observation angle of 0.2° in accordance with ASTM E1709.

13. A method of coating an article, comprising:
applying the composition of any one of claims 1 to 10 over at least a portion of a surface of the article; and
curing the composition to form a coating, wherein the coating comprises a coefficient of retro-reflection (R_{A}) of at least 6 cd/ft/ft² as measured using a retroreflectometer with an entrance angle of −4° and an observation angle of 0.2° in accordance with ASTM E1709.

14. A method for producing retroreflective particles for use in a powder coating composition, comprising:
applying a liquid pigment coating composition comprising a binder resin, an organic pigment over at least portions of a plurality of retroreflective particles, each retroreflective particle comprising a base particle having a metallic coating disposed over at least a portion of the base particle, to form pigmented retroreflective particles; and
applying a substantially transparent siloxane coating over the pigmented retroreflective particles.

15. The method of claim 14, further comprising the step of combining the pigmented retroreflective particles with a film-forming resin.

16. The method of claim 14, wherein the liquid pigment coating composition comprises:
binder resin in an amount from 15 to 35 wt. %;
organic pigment in an amount from 5 to 15 wt. %; and
solvent in an amount from 55 to 75 wt. %, based on a total weight of the pigment coating composition.

17. The method of claim 14, wherein the organic pigment can impart a maximum haze up to 10% as determined in accordance with ASTM D1003.

18. The method of claim 14, wherein the organic pigment is selected from Pigment Green 36, Pigment Yellow 138, Pigment Yellow 139, Pigment Red 179, Pigment Red 202, Pigment Violet 29, Pigment Blue 15:3, azo (monozao, diszao, β-naphthol, naphthol AS, salt type (lakes), benzimidazalone, condensation, metal complex, isoindolinone, isoindoline) and polycyclic (phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone) pigments, and combinations of the foregoing.
